(19) United States
(12) Patent Application Publication
(10) Pub. No.: US 2006/0114367 A1
(43) Pub. Date: Jun. 1, 2006

(54) Liquid crystal display apparatus

(75) Inventors: Yoshiaki Aramatsu, Tottori-Shi (JP); Osamu Kobayashi, Tottori-Shi (JP)

Correspondence Address: MCDERMOTT WILL & EMERY LLP, 600 13TH STREET, N.W., WASHINGTON, DC, 20005-3096, US

(73) Assignees: SANYO ELECTRIC CO., LTD.; TOTTORI SANYO ELECTRIC CO., LTD.

(21) Appl. No.: 11/239,099

(22) Filed: Sep. 30, 2005

(30) Foreign Application Priority Data
Sep. 30, 2004 (JP) 2004-286356

(51) Int. Cl. G02F 1/1333

(52) U.S. Cl. 349/58

(57) ABSTRACT

In a liquid crystal display apparatus having a backlight disposed behind a liquid crystal display panel 10, the liquid crystal display panel 10 has first and second substrates 11 and 21 disposed to face each other. The second substrate 21 has a common electrode 20 laid in a display area 12 thereon. The second substrate 21 further has a light-shielding inner black matrix 22 laid around the display area 12 and a light-shielding electrically insulated black matrix 22A, 22B, and 22C laid outside the inner black matrix 22 and electrically separated from the inner black matrix 22 and the common electrode 19. The liquid crystal display panel 10 is held, at the periphery thereof, by metal support frames 32 and 33.

This application is based on Japanese Patent Application No. 2004-286356 filed on Sep. 30, 2004, the contents of which are hereby incorporated by reference.

### BACKGROUND OF THE INVENTION

1. Field of the Invention

The present invention relates to a liquid crystal display apparatus, and more particularly to a liquid crystal display apparatus having a light-shielding black matrix (BM) disposed around a peripheral portion of a liquid crystal display panel.

2. Description of Related Art

In a liquid crystal display panel, two transparent substrates having electrodes and the like formed thereon are placed to face each other, and are fixed together with a sealing member laid around the periphery thereof. The transparent substrates and the sealing member thus leave a space inside it, where liquid crystal is sealed in. For example, an active-matrix liquid crystal display panel is structured as follows. On one substrate, signal lines and scan lines are laid in a grid-like pattern. Near each of the crossings between the signal lines and the scan lines, a thin-film transistor is formed, and, within each of the areas demarcated by the signal lines and the scan lines, a pixel electrode is formed that is connected to the corresponding thin-film transistor.

On the other substrate, in the position facing each pixel electrode, a R (red), G (green), or B (blue) filter layer is disposed. Between each filter layer is laid a black matrix, and the filer layer and the black matrix are covered with a transparent electrode serving as a common electrode.

One commonly used type of liquid crystal display apparatus is transmissive liquid crystal display apparatuses having a backlight disposed behind a liquid crystal display panel. The liquid crystal display panel is lit with the light emitted from the backlight so that the light transmitted through the liquid crystal display panel makes images visible. The backlight is typically built with a fluorescent lamp (FL), such as a hot-cathode fluorescent lamp (HCFL) or cold-cathode fluorescent lamp (CCFL), or a light-emitting diode (LED).

Depending on their design, backlights are classified into a direct-lit type, a side-lit type, and a planer-light-source type. In the direct-lit type, a light source is disposed behind a liquid crystal display panel. This tends to make a thick liquid crystal display apparatus. For this reason, the direct-lit type is typically adopted in liquid crystal display apparatuses in which high brightness is expected, such as large- to medium-screen liquid crystal display apparatuses and liquid crystal display apparatuses for use in television monitors.

In a planer-light-source backlight, a planar light source that emits light from all over a surface is disposed behind a liquid crystal display panel. Planer-light-source backlights can be made slim, but are expensive, making them a less favored choice.

On the other hand, the side-lit type is typically adopted in liquid crystal display apparatuses in which slimness is sought but only moderate brightness is expected, such as liquid crystal display apparatuses for use in small-size measurement appliances, navigation apparatuses, vehicle-mounted display apparatuses such as various monitors, portable information terminals, and cellular phones.

In a side-lit backlight, a light guide plate is used to convert the light from a light source disposed at a side of a liquid crystal display panel into planar light. The light guide plate has a reflective plate disposed on the back surface thereof, and has an optical sheet called a prism sheet disposed on the front surface thereof. Typically used as the light source is a straight CCFL or one or a plurality of LEDs as conventionally available. In side-lit backlights, the light source is disposed at an edge of the light guide plate; thus, these backlights are also called edge-lit backlights.

Now, with reference to FIGS. 4 and 5, a description will be given of a specific example of a conventional liquid crystal display panel having terminals at one side (that is, single-side-terminaled). FIG. 4 is a schematic plan view showing a conventional single-side-terminaled liquid crystal display panel as seen through one of the substrates thereof. FIG. 5 is a schematic sectional view of FIG. 4 along line A-A.

In the liquid crystal display panel 10A, within a display area 12 on a first substrate 11, which is a transparent substrate, scan lines and signal lines are formed in a grid-like pattern. In each of the areas demarcated by the scan lines and the signal lines, a pixel electrode is formed. Near each of the crossings between the scan lines and the signal lines, a thin-film transistor (TFT) is formed, which is connected to the corresponding pixel electrode. How these components, namely the lines, the thin-film transistor, and the pixel electrode just mentioned, are structured is not specifically illustrated, but, in FIG. 5, they are collectively shown as a first structure 13.

At one of the shorter sides of the first substrate 11, outside the display area (that is, in a frame portion), connection terminals 14 are provided. Via the connection terminals 14, the signal lines and the scan lines are connected to an externally provided control circuit board (unillustrated). On the first substrate 11, peripheral circuits 16 (of which only two are shown in FIG. 4) are disposed that are connected to the signal lines, the scan lines, and a common conductor. The connection terminals 14 are, as necessary, connected via conductors 15 to the peripheral circuits 16, the signal liens, the scan lines, and the common conductor.

In the present specification, of all the conductors 15, those connected to the signal lines are called source lines 15s, those connected to the scan lines are called gate lines 15g, and those connected to the common conductor are called common lines 15c. These are distinguished whenever they need to be discussed separately from the conductors 15.

The connection terminals 14 are, for example as disclosed in Japanese Patent Application Laid-open No. 2002-090770, connected to the output terminals of a TCP (tape carrier package) 17. The input terminals of the TCP 17 are connected to the output terminals of an externally provided control circuit board, so that drive signals from a control circuit are fed to the scan line and the signal lines.

The conductors 15, the peripheral circuits 16, and the like are formed by the same process as the scan lines, the TFTs, and the like. Thus, the conductors 15, the peripheral circuits 16, and the like are formed with the same material as the scan lines and the like, and, for electrical isolation, their surfaces are coated with an inorganic insulating film and a resist film formed of silicon oxide or silicon nitride.

In part of the four corners of the first substrate 11, a plurality of (in the example currently discussed, two) transfer electrodes 18a and 18b are provided. The transfer electrodes 18a and 18b also are formed by the same process as the scan lines and the like, and are formed with the same material as the scan lines and the like. The transfer electrodes 18a and 18b and the common lines 15c are connected together directly or via the connection terminals 14 so as to be kept at the same potential.

When the connection terminals 14 and the TCP 17 are connected together, the transfer electrodes 18a and 18b are connected via the common lines 15c to the TCP 17, and are connected further via the TCP 17 to the control circuit board.

The transfer electrodes 18a and 18b are electrically connected to a common electrode 19, which will be described in detail later. Thus, a predetermined voltage outputted from the externally provided control circuit board is applied to the common electrode 19. The gate lines 15g and the source lines 15s may be arranged the other way around.

On the other hand, within the display area 12 on a second substrate 21, which is a transparent substrate, a color filter and a black matrix are formed. The color filter has filter layers so laid as to face the pixel electrodes on the first substrate 11, each filter layer corresponding to the pixel it faces. How the color filter and the black matrix just mentioned are structured is not specifically illustrated, but, in FIG. 5, they are collectively shown as a second structure 20.

On the second substrate 21 is further formed, at least all over the display area 12, a common electrode 19, which is a transparent electrode formed of indium oxide, tin oxide, or the like. Moreover, around a peripheral portion of the second substrate 21, a black matrix 22 is laid so as to cover around the outline of the display area 12. The black matrix 22 prevents the light from a backlight (unillustrated) from leaking through outside the display area 12. The black matrix 22 is typically formed of low-reflection chromium metal.

On the first substrate 11, around the display area 12 is laid a sealing member 23 except where an injection hole (unillustrated) is formed. Moreover, contact members 24 are laid on top of the transfer electrodes 18a and 18b. The sealing member 23 is formed of, for example, a thermosetting resin, such as epoxy resin, mixed with insulating particles as a filler. The contact members 24 are formed of a resin and a filler, similar to those of which the sealing member 23 is formed, mixed further with electrically conductive particles (unillustrated).

The sealing member 23 covers substantially all of the conductors 15 (including the source lines 15s, the gate lines 15g, and the common lines 15c) and the peripheral circuits 16, which are laid between the first and second substrates 11 and 21 in a peripheral portion thereof. This ensures increased bonding strength and electrical insulation between the first and second substrates 11 and 21.

The electrically conductive particles mixed in the contact members 24 are, for example, spherical resin particles plated all over the surface thereof with a flexible, electrically insulating metal such as Au. The particle size of the electrically conductive particles is slightly larger than the cell gap of the liquid crystal display panel 10A. Thus, when the first and second substrates 11 and 21 are fitted together, no gap is left between the electrically conductive particles, the transfer electrodes 18a and 18b, and the common electrode 19. This helps keep the electrically conductive particles in contact with the transfer electrodes 18a and 18b and the common electrode 19.

From the externally provided control circuit, a predetermined voltage is fed to the common electrode 19 via the common lines 15c and the transfer electrodes 18a and 18b. In FIG. 5, reference numeral 25 indicates spacer particles, and reference numeral 26 indicates liquid crystal.

Now, with reference to FIGS. 6 and 7, a description will be given of a liquid crystal display apparatus incorporating a conventional side-lit backlight of this type. FIG. 6 is an exploded perspective view of the liquid crystal display panel of the liquid crystal display apparatus disclosed in Japanese Patent Registered No. 2724642, showing the state of the liquid crystal display panel before being assembled into the liquid crystal display apparatus. FIG. 7 is a diagram showing the structure of the supporting members used in the liquid crystal display apparatus shown in FIG. 6. In these figures, such parts as are found also in the liquid crystal display panel 10A shown in FIGS. 4 and 5 are identified with common reference numerals, and no detailed explanations thereof will be repeated.

The liquid crystal display apparatus 30 is composed essentially of a liquid crystal display panel 10B, a backlight 31, and bezels (support frames) 32 and 33. The liquid crystal display panel 10B is structured like the previously described liquid crystal display panel 10A shown in FIGS. 4 and 5. The backlight 31 illuminates the liquid crystal display panel 10B from behind. The bezels 32 and 33, which are made of metal, support the liquid crystal display panel 10B and the backlight 31.

In the liquid crystal display apparatus 30, the liquid crystal display panel 10B is disposed between the support frame 32, which is disposed at the front, and the support frame 33, which is disposed at the back. The support frame 33 snaps onto the support frame 32 so that the liquid crystal display panel 10B is held in between. The display area of the liquid crystal display panel 10B shows frontward through an window formed in the front support frame 32.

The backlight 31 includes a light guide plate 34 and a light source 35. The light guide plate 34 is fitted into a recessed portion formed in the support frame 33, which constitutes the casing of the liquid crystal display apparatus 30. The light source 35, built with one or more lamps, is so disposed as to face and remain in close or intimate contact with a side end surface of the light guide plate 34 that is used as the light introduction surface thereof.

As shown in FIG. 7, in the four corners of the support frame 33, holding members 36 to 39 are provided that are electrically insulating. The holding members 36 to 39 include liquid crystal display panel positioning portions 40, light guide plate positioning portions 41, light source positioning portions 42, a lead holding portion 44, and a lead routing portion 45.

The display panel positioning portions 40 keeps the liquid crystal display panel 10B in position relative to the holding members 36 to 39. The light guide plate positioning portions 41 keeps the light guide plate 34 in position relative to the holding members 36 to 39. The light source positioning portions 42 keeps the light source 35 in position relative to the holding members 36 to 39. The lead holding portion 44 keeps the input/output leads 43 of the light source 35 fixed inside the support frame 33. The lead routing portion 45 permits the input/output leads 43 to be led out as a bundle.

In the liquid crystal display apparatus 30 described above, the ends of the liquid crystal display panel 10B make contact with the metal support frames 32 and 33. Generally, a liquid crystal display apparatus is fabricated by first bonding together large motherboards, having formed thereon a plurality of liquid crystal display panel areas of a predetermined size, with a sealing member and then cutting it into individual liquid crystal display panels of the predetermined size. Here, when the motherboards are cut, a slight error may arise in the cutting positions, causing an electrically conductive member to be exposed at an end surface. If the metal support frames 32 and 33 make contact with an electrically conductive member of the liquid crystal display panel 10B, short circuiting or electrolytic corrosion may result there.

For this reason, as shown in part X in FIG. 5, electrically conductive materials such as the common electrode 19 and the black matrix 22 are formed are located a certain distance away from the ends of the second substrate 21, where glass cut surfaces are exposed. In this way, even when an error arises in the cutting positions during the fabrication of the liquid crystal display panel, no electrically conductive material is exposed, and thus no short circuiting or electrolytic corrosion results. This applies also in a case where, as in the liquid crystal display apparatus disclosed in Japanese Patent Application Laid-open No. 2003-215550, no black matrix is laid around a peripheral portion of the display area of the second substrate 21.

When such a liquid crystal display panel is fabricated, it is necessary to allow for an error of about 200 μm in the cutting positions. Thus, it is impossible to locate electrically conductive materials such as the common electrode 19 and the black matrix 22 in an area at least 200 μm away from the ends of the second substrate 21, where glass cut surfaces are exposed.

The conventional liquid crystal display panels 10A and 10B described above, however, have the following disadvantages. Light leaks between the light-shielding black matrix 22 and the glass cut surfaces. As a result, when the liquid crystal display apparatus is viewed from an oblique direction, the light that has thus leaked degrades display quality.

FIG. 8 shows, as an example, a liquid crystal display apparatus 50 having the liquid crystal display panel 10A shown in FIGS. 4 and 5 held between metal support frames 32 and 33. The light Lin incident from a backlight (unillustrated) on the liquid crystal display panel 10A is reflected on the surface of the support frame 33. The reflected light Lout passes through the gap between the black matrix 22 and the support frame 33, and exits from within the display area on the second substrate 21.

Light also leaks via paths other than that shown in FIG. 8. For example, light that has been refracted repeatedly inside the first substrate 11 and then exited through an end surface of the first substrate 11 may be reflected on the support frame 33 so as to exit from within the display area.

### SUMMARY OF THE INVENTION

An object of the present invention is to provide a liquid crystal display apparatus that does not suffer from light leakage even when viewed from an oblique direction and that is free from short circuiting and electrolytic corrosion.

To achieve the above object, according to the present invention, a liquid crystal display apparatus is provided with: a liquid crystal display panel having liquid crystal sealed between first and second substrates disposed to face each other, the second substrate having a common electrode laid in a display area thereon, the second substrate having a light-shielding black matrix laid around the display area thereon; a backlight disposed behind the liquid crystal display panel; and a metal support frame supporting the liquid crystal display panel at the periphery thereof. Here, the black matrix is composed of an inner black matrix located in an inner portion of the black matrix and an electrically insulated black matrix located outside the inner black matrix and electrically separated from the inner black matrix and the common electrode.

In the present specification, “electrically insulated” denotes an electrically floating state, that is, a state electrically separated from electrically conductive members such as the inner black matrix and the common electrode. Thus, when in contact with the metal support frame, the electrically insulated black matrix is at the same potential as the support frame; by contrast, when not in contact with the metal support frame, it is at an indefinite potential.

Preferably, according to the present invention, in the liquid crystal display apparatus described above, the electrically insulated black matrix is formed in the shape of a strip extending parallel to an end surface of the second substrate. In this case, the electrically insulated black matrix may be laid along all the four sides of the second substrate, or along any smaller number thereof.

Preferably, according to the present invention, in the liquid crystal display apparatus described above, as the electrically insulated black matrix, a plurality of them are formed, each electrically separated from another. In this case, a plurality of electrically insulated black matrices may be laid parallel to the direction of the length thereof, or may be laid in a direction perpendicular to the direction of the length thereof, or may be laid in a combination of parallel and perpendicular arrangements.

Thanks to the features described above, the present invention offers the following benefits. According to the present invention, the electrically insulated black matrix is in an electrically floating state. Thus, when in contact with the metal support frame, the electrically insulated black matrix is at the same potential as the support frame; by contrast, when not in contact with the metal support frame, it is at an indefinite potential. In either case, the outer electrically insulated black matrix is electrically separated from the inner black matrix and the common electrode, and therefore no current flows between the metal support frame and the other black matrix. Thus, no short circuiting or electrolytic corrosion occurs through the electrically insulated black matrix. Moreover, no light leaks even when viewed from an oblique direction, and this helps enhance display quality at the periphery.

According to the present invention, the electrically insulated black matrix is laid equidistantly from an end of one of the substrates. Thus, the distance between the metal support frame and the electrically insulated black matrix is constant, regardless of where it is measured. This eliminates variations in the quality of the liquid crystal display apparatus.

According to the present invention, the electrically insulated black matrix is composed of a plurality of black matrices, each electrically separated from another. Thus, when the plurality of black matrices are separated parallel to the direction of their length, the electrical resistance between the metal support frame and the other black matrix is large. This makes short-circuiting and electrolytic corrosion via the black matrix less likely. On the other hand, when the plurality of black matrices are separated perpendicularly to the direction of their length or in a combination of parallel and perpendicular arrangements, the electrically insulated black matrix can be laid appropriately according to the shape of the conductor laid around it and other factors. This helps increase flexibility in design.

According to the present invention, in proportion to the size of the gap, the electrically insulated black matrix becomes increasingly unlikely to make contact with the metal support frame. This reduces the risk of short circuiting and electrolytic corrosion, but increases the leakage of light when viewed from an oblique direction. The size of the gap is therefore determined appropriately through experiments. What should be noted here is that, during cutting in the fabrication process of the liquid crystal display panel, an error in the cutting positions causes the black matrix to produce burrs at the ends of one of the substrates. To prevent short circuiting and electrolytic corrosion attributable to such burrs, the distance needs to be large, in which case, inconveniently, the leakage of light when viewed from an oblique direction is large.

According to the present invention, since the leakage of light is largest when viewed from an oblique direction from the side opposite to where the light source of a side-lit backlight is disposed, it is possible to effectively reduce the leakage of light when viewed from an oblique direction.

### BRIEF DESCRIPTION OF THE DRAWINGS

FIG. 1 is a plan view showing the liquid crystal display panel used in an liquid crystal display apparatus embodying the invention;

FIG. 2 is an enlarged view of part Y shown in FIG. 1;

FIG. 3 is a sectional view of FIG. 1 taken along line B-B, showing the liquid crystal display panel shown in FIG. 1 held between support frames;

FIG. 4 is a plan view showing a conventional liquid crystal display panel;

FIG. 5 is a sectional view of FIG. 4 taken along line A-A;

FIG. 6 is an exploded perspective view of a conventional liquid crystal display apparatus, showing the state thereof before a liquid crystal display panel is assembled into it;

FIG. 7 is a perspective view showing the structure of the support members used in the liquid crystal display apparatus shown in FIG. 6; and

FIG. 8 is a sectional view showing the liquid crystal display panel shown in FIG. 5 held between support frames.

### DETAILED DESCRIPTION OF PREFERRED EMBODIMENTS

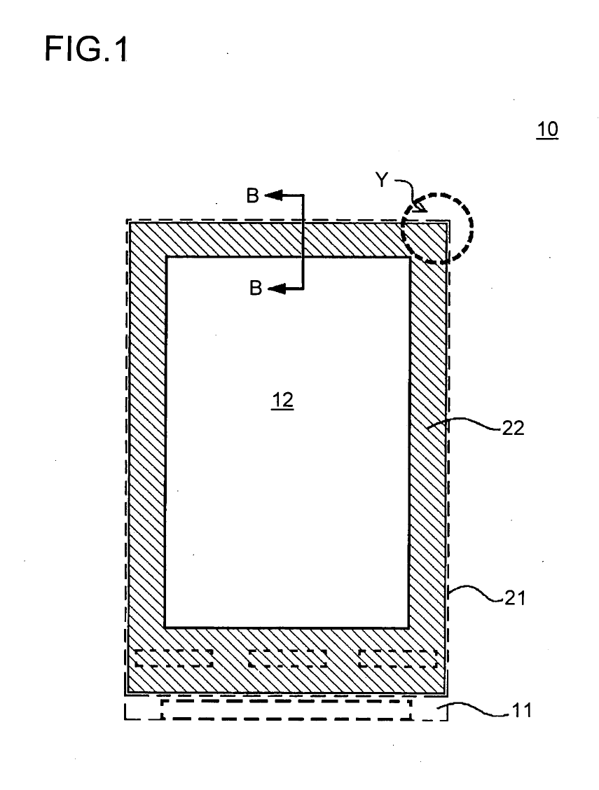

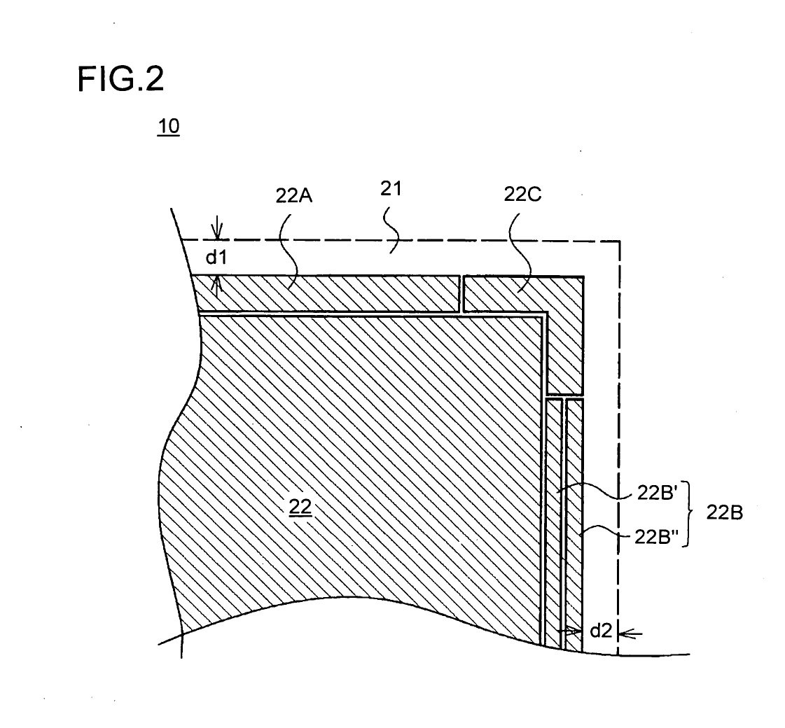

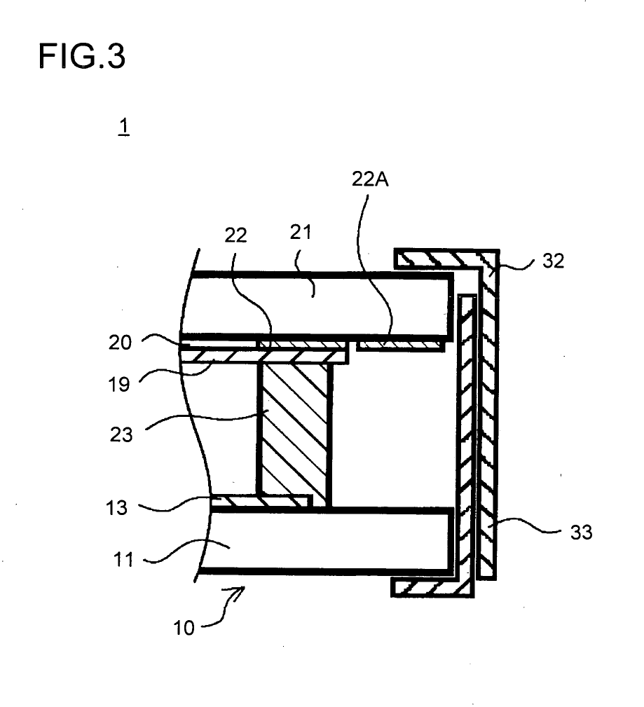

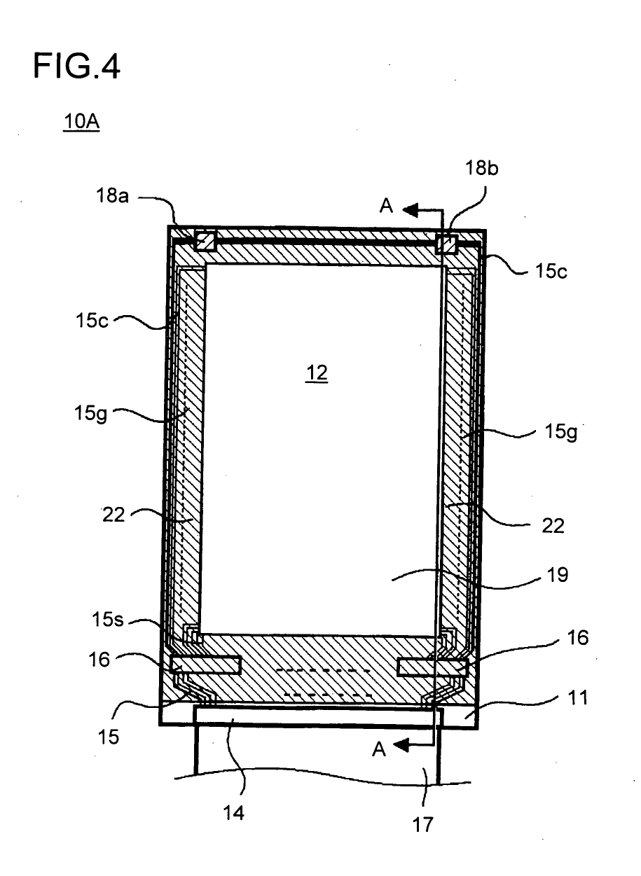

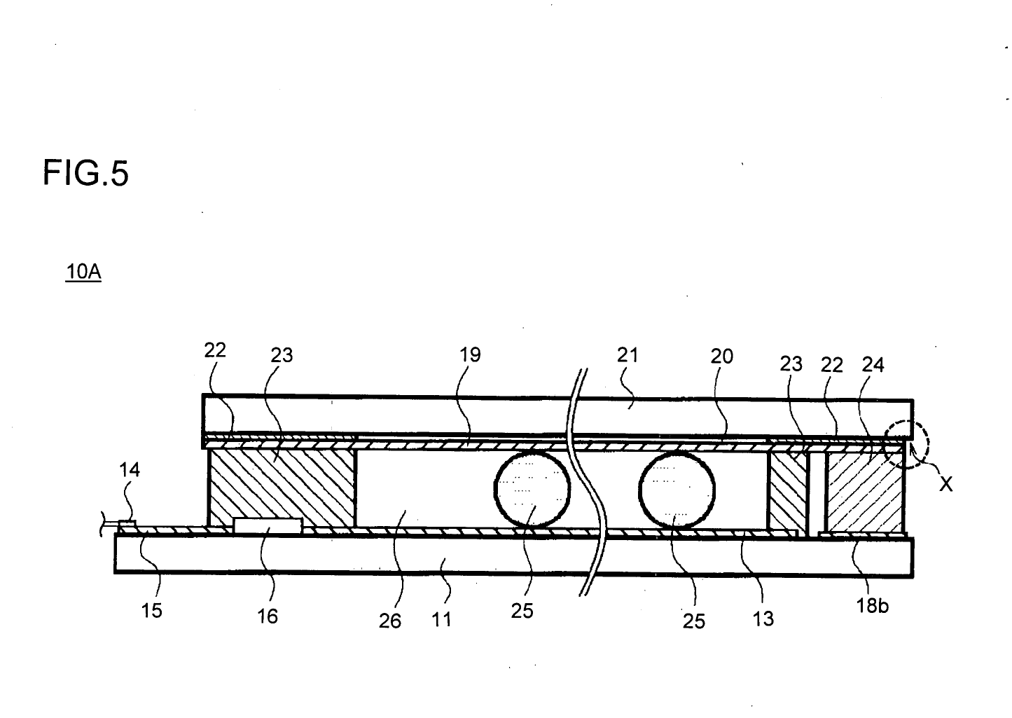

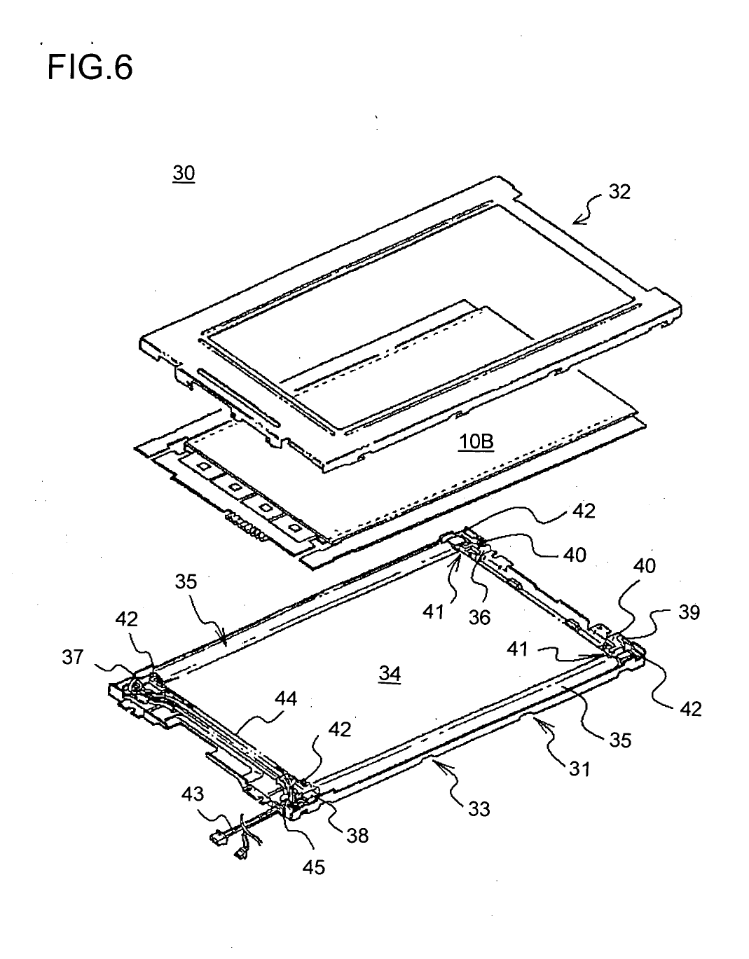

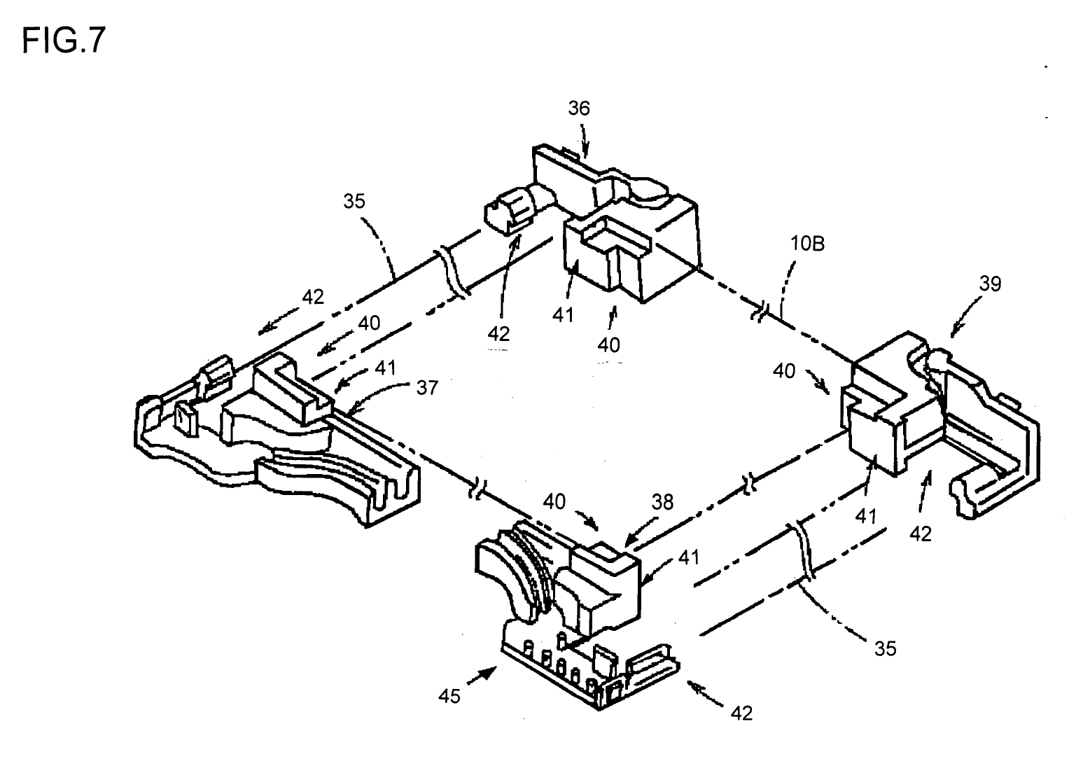

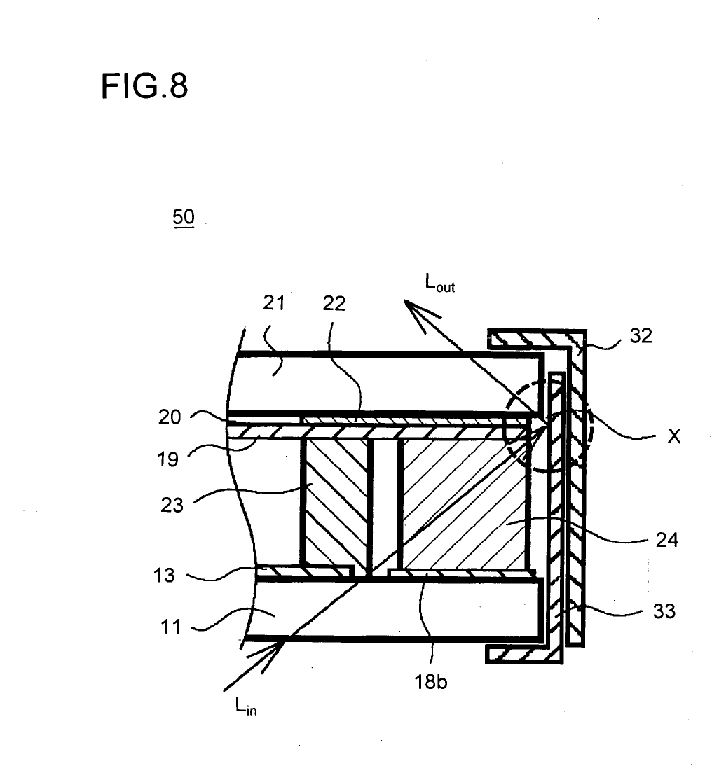

Hereinafter, the best mode in which the present invention can be carried out will be described with reference to the drawings, taking up a transmissive liquid crystal display apparatus as an example. FIG. 1 is a plan view showing the liquid crystal display panel used in a liquid crystal display apparatus embodying the invention. FIG. 2 is an enlarged view of part Y shown in FIG. 1. FIG. 3 is a section of FIG. 1 taken along line B-B, showing the liquid crystal display panel shown in FIG. 1 held between support frames. In FIG. 1, part of the second substrate, which forms the display surface, is cut out to show the interior. For the sake of convenience, such parts similar to those found in the conventional example shown in FIGS. 4 to 8 are identified with common reference numerals, and no explanations thereof will be repeated.

The liquid crystal display panel 10 has a first and a second substrate 11 and 21, both transparent, disposed to face each other. On the surface of the second substrate 21 facing the first substrate 11, within a display area 12, a black matrix is formed in a grid-like pattern. The black matrix has a large number of openings formed therein, of which each is filled with one of color filter materials of three, namely R (red), G (green), and B (blue), or more colors.

Around the display area 12 on the second substrate 21, a black matrix 22 is laid to almost reach the ends of the four sides and the ends of the four corners. As shown in FIG. 2, around the black matrix 22, there are laid black matrices 22A, 22B, and 22C. The black matrices 22, 22A, 22B, and 22C are formed of low-reflection chromium metal or the like.

The black matrices 22A and 22B are formed in the shape of a strip extending along and parallel to a side of the second substrate 21a predetermined distance d1 or d2 away from the end surface of the second substrate 21. This makes constant the distance between the support frame 33 (see FIG. 3) and the black matrices 22A and 22B. Thus, no variation arises in the quality of the liquid crystal display apparatus 1. The black matrix 22C is laid in the shape of L along two sides of the second substrate 21a distance d1 or d2 away from the end surface of the second substrate 21.

The black matrices 22A, 22B, and 22C are laid a slight distance away from the black matrix 22. The black matrices 22A, 22B, and 22C are laid a slight distance away from one another. The black matrix 22B is divided, parallel to an end surface of the second substrate 21, into two black matrices 22B′ and 22B″ that are laid a slight distance away from each other.

The black matrices 22A, 22B, and 22C are all located outside the black matrix 22, which is located around the display area 12 of the second substrate 21, and are electrically separated from the black matrix 22. Thus, the black matrices 22A, 22B, and 22C are in an electrically floating state.

In the present specification, the black matrices 22, 22A, 22B, and 22C are distinguished as follows. The black matrix 22 is called the “inner black matrix”. On the other hand, the black matrices 22A, 22B, and 22C, which are so laid as to be in an electrically floating state, are called the “electrically insulated black matrices”.

The electrically insulated black matrix 22B is composed of two divided electrically insulated black matrices 22B′ and 22B″; alternatively, it may be laid, like the black matrix 22A, in the shape of a single strip. The electrically insulated black matrices 22A, 22B, and 22C are separated from one another; alternatively, they may be laid as a single black matrix so long as it is electrically separated from the inner black matrix 22.

It is, however, preferable that, as shown in FIG. 2, the electrically insulated black matrix be divided into a plurality of parts. This makes it possible to lay electrically insulated black matrices only where they are necessary, with consideration given to the electrodes and conductors laid around the second substrate 21. This helps increase the flexibility in the design of the liquid crystal display panel 10.

The smaller the distance between the electrically insulated black matrices 22A, 22B, and 22C and the inner black matrix 22, the less the leakage of light through the gap between them. During the cutting of the liquid crystal display panel 10, however, an error in the cutting positions may cause an electrically insulated black matrix to be cut, leaving shavings thereof behind; otherwise, electrically conductive dust or the like may settle. In any of these cases, short circuiting may result. To avoid this, it is preferable that a distance of about 10 μm be secured between the electrically insulated black matrices 22A, 22B, and 22C and the inner black matrix 22. The same applies to the distance between the electrically insulated black matrices 22B′ and 22B″.

The distances d1 and d2 between the electrically insulated black matrices 22A and 22B and the second substrate 21 may or may not be equal. The smaller the distances d1 and d2, the less the leakage of light, but the more likely, in a similar manner as described above, burrs are produced in the electrically insulated black matrices 22A and 22B when the liquid crystal display panel 10 is cut. When the liquid crystal display apparatus is assembled together by the use of the support frame 33 (see FIG. 3), such burrs may short-circuit to the metal support frame. To avoid this, for higher safety, it is preferable that the distances d1 and d2 be about 100 μm.

It should be noted, however, that the electrically insulated black matrices 22A, 22B, and 22C are in an electrically floating state. Thus, even if they electrically short-circuit to the metal support frame 33, it does not readily lead to short circuiting with the inner black matrix 22 or electrolytic corrosion. The distances d1 and d2 may therefore be made equal to zero.

FIG. 3 is a sectional view showing the liquid crystal display apparatus of the currently discussed embodiment, taken along line B-B shown in FIG. 1. The liquid crystal display apparatus 1 is produced by holding the liquid crystal display panel 10 structured as described above between metal support frames 32 and 33 and combining a backlight appropriately therewith.

In the display area 12 (see FIG. 1) on the second substrate 21 of the liquid crystal display apparatus 1, the second structure 20 is provided, and on top thereof is laid the common electrode 19. Around the display area 12, the inner black matrix 22 is laid. Around the inner black matrix 22, the electrically insulated black matrices 22A, 22B, and 22C (see FIG. 2) are laid.

The electrically insulated black matrices 22A, 22B, and 22C are electrically separated from the inner black matrix 22. Thus, even when an error in the cutting positions of the liquid crystal display panel 10 causes the electrically insulated black matrices 22A, 22B, and 22C to be exposed, the black matrix 22 and the common electrode 19 remain electrically separated from the support frame 33.

This permits the electrically insulated black matrices 22A, 22B, and 22C to be laid to almost reach the ends of the second substrate 21. Thus, it is possible to reduce the leakage of light through the gap between the electrically insulated black matrices 22A, 22B, and 22C and the ends of the second substrate 21. In this way, it is possible to realize a liquid crystal display apparatus 1 that can display high-quality images with less deterioration in the displayed image attributable to light leakage even when the boundary of the display area 12 is viewed from an oblique direction.

In this embodiment, electrically insulated black matrices are laid along all the four sides of the second substrate 21. When a side-lit backlight is used, however, electrically insulated black matrices may be laid along one to four of all the sides of the second substrate 21. Specifically, when a side-lit backlight is used, much light leaks at the side opposite to the light source. Thus, light leakage can be reduced by laying an electrically insulated black matrix along one side opposite to the light source, or along three sides other than the one facing the light source. Correspondingly, electrically insulated black matrices may be laid in two to four of all the four corners of the second substrate 21.

For example, when a light source built with one LED or a plurality of LEDs arrayed in a straight line is used, an electrically insulated black matrix is laid at least along the side opposite to the light source. As necessary, electrically insulated black matrices may additionally be laid in the two corners opposite to the light source.

When a U-shaped cold-cathode lamp is used as the light source of a side-lit backlight, electrically insulated black matrices are laid along three sides, specifically the side toward which the cold-cathode lamp is open and the two sides adjacent thereto. Electrically insulated black matrices may additionally be laid in the two corners in which those electrically insulated black matrices connect to one another.

The present invention can be applied not only to transmissive liquid crystal display apparatuses but also, in similar manners, to semitransmissive liquid crystal display apparatuses. The present invention is equally applicable to liquid crystal display apparatuses that use a backlight of not only the side-lit type but also the direct-lit or planer-light-source type.

### List of Reference Numerals

1, 30, 50 Liquid Crystal Display Apparatus
10, 10A, 10B Liquid Crystal Display Panel
11 First Substrate
12 Display Area
18a, 18b Transfer Electrode
19 Common Electrode
21 Second Substrate
22 Inner Black Matrix
22A, 22B, 22C Electrically Insulated Black Matrix
23 Sealing Member
31 Backlight
32, 33 Support Frame
35 Light Source

What is claimed is:

1. A liquid crystal display apparatus comprising:
a liquid crystal display panel having liquid crystal sealed between first and second substrates disposed to face each other, the second substrate having a common electrode laid in a display area thereon, the second substrate having a light-shielding black matrix laid around the display area thereon;
a backlight disposed behind the liquid crystal display panel; and
a metal support frame supporting the liquid crystal display panel at a periphery thereof,
wherein the black matrix comprises an inner black matrix located in an inner portion of the black matrix and an electrically insulated black matrix located outside the inner black matrix and electrically separated from the inner black matrix and the common electrode.

2. The liquid crystal display apparatus of claim 1,
wherein the electrically insulated black matrix is formed in a shape of a strip extending parallel to an end surface of the second substrate.

3. The liquid crystal display apparatus of claim 1,
wherein a plurality of the electrically insulated black matrix are formed, each electrically separated from another.

4. The liquid crystal display apparatus of claim 1,
wherein a gap of 100 μm or less is left between the electrically insulated black matrix and an end of the second substrate.

5. The liquid crystal display apparatus of claim 1,
wherein the backlight has a light source disposed to face a side of the liquid crystal display panel, and
wherein the electrically insulated black matrix is located at a side of the liquid crystal display panel opposite to the side thereof facing the light source.
